(19) United States
(12) Patent Application Publication
(10) Pub. No.: US 2009/0268027 A1
(43) Pub. Date: Oct. 29, 2009

(54) Driving Assistance System And Vehicle

(75) Inventor: Changhui Yang, Osaka (JP)

Correspondence Address: NDQ&M WATCHSTONE LLP, 1300 EYE STREET, NW, SUITE 1000 WEST TOWER, WASHINGTON, DC, 20005, US

(73) Assignee: Sanyo Electric Co., Ltd., Osaka (JP)

(21) Appl. No.: 12/428,726

(22) Filed: Apr. 23, 2009

(30) Foreign Application Priority Data
Apr. 23, 2008 (JP) 2008-112040

(51) Int. Cl. H04N 7/18

(52) U.S. Cl. 348/148; 348/E07.085

(57) ABSTRACT

A driving assistance system has: a bird's eye conversion portion that projects mutually different first and second camera images from a camera portion onto a bird's eye view coordinate plane parallel to the ground to convert them into first and second bird's eye view images; a candidate region setting portion that compares the first and second bird's eye view images to set a solid object candidate region on the bird's eye view coordinate plane; and a solid object region estimation portion that detects, within the solid object candidate region, an unnecessary region to be excluded from a solid object region to estimate the solid object region from a remaining region obtained by excluding the unnecessary region from the solid object candidate region. The solid object region estimation portion detects the unnecessary region based on the positional relationship between a camera position, which is the position of the camera portion as projected on the bird's eye view coordinate plane, and the positions of candidate pixels, which are pixels belonging to the solid object candidate region.

This nonprovisional application claims priority under 35 U.S.C. § 119(a) on Patent Application No. 2008-112040 filed in Japan on Apr. 23, 2008, the entire contents of which are hereby incorporated by reference.

### BACKGROUND OF THE INVENTION

1. Field of the Invention

The present invention relates to a driving assistance system. More particularly, the present invention relates to a technology for estimating, from a result of shooting by a camera fitted to a mobile object, a solid object region, i.e. a region where a solid object (three-dimensional object) appears. The present invention also relates to a vehicle employing such a driving assistance system.

2. Description of Related Art

A solid object standing on a road surface can be an obstacle to a vehicle, and driver's overlooking it may lead to a collision accident. Such collision accidents are particularly likely to occur in the blind spots of drivers. Thus there has been proposed a technique according to which a vehicle is fitted with a camera for monitoring regions that tend to be the driver's blind spots so that an image obtained from the camera is displayed on a display device disposed near the driver's seat. There has also been developed a technology for converting a camera image obtained from a camera into a bird's eye view image for display. The bird's eye view image is an image of a vehicle as viewed from up in the sky, and displaying it makes it easier for the driver to have the sense of distance to a solid object. There has been proposed a method according to which, in a driving assistance system that can generate a bird's eye view image, a solid object region is estimated from two bird's eye view images obtained by shooting at different times. With this method, first the displacement between the two bird's eye view images are corrected based on their image data, and then an solid object region is estimated based on the differential image between the two bird's eye view images.

Inconveniently, however, with this method, if a shadow of a solid object produced by external illumination, such as light from the sun, appears in the images, no distinction can be made between the part where the solid object itself appears and the part where its shadow appears; thus the shadow part may be detected as part of the solid object. This may lead to an incorrect determination of the position of the solid object. FIG. 20 shows a result of estimating a solid object region including a shadow part. FIG. 20, and also FIGS. 21A to 20D described later, assumes use of a rear camera that shoots rearward of a vehicle. In FIG. 20, the left side is the side where the vehicle is located.

Moreover, when a solid object region is estimated by the above method, an end part of a shadow of the vehicle itself (the very vehicle on which the camera and the driving assistance system are installed) may be included in the solid object region. How this happens will now be explained with reference to FIGS. 21A to 21D. In FIGS. 21A to 21D, the bottom side is the side where the vehicle is located.

FIGS. 21A and 21B show the bird's eye view images based on the camera images shot in the previous and current frames respectively. In FIGS. 21A and 21B, the black regions indicated by reference signs 901 and 902 are the regions of the shadow of the vehicle itself in the bird's eye view images of the previous and current frames respectively. FIG. 21C shows the bird's eye view image of the previous frame after displacement correction. The displacement correction is so performed that, between the bird's eye view image of the current frame and the bird's eye view image of the previous frame after displacement correction, the points corresponding to the same points on the road surface coincide in coordinates. In FIGS. 21C and 21D, the hatched regions are regions where no image information is available.

Then the differential image between the bird's eye view image of the current frame, shown in FIG. 21B, and the bird's eye view image of the previous frame after displacement correction, shown in FIG. 21C, is generated, and the individual pixel values of that differential image are binarized to generate a binarized differential image. This binarized differential image is shown in FIG. 21D. In the differential image, the pixels having pixel values equal to or greater than a predetermined threshold value are identified as distinctive pixels, and the other pixels are identified as non-distinctive pixels. Giving the distinctive pixels a pixel value of 1 and the non-distinctive pixels a pixel value of 0 produces the binary differential image. In FIG. 21D, the part where the pixel values are 1 is shown white, and the part where the pixel values are 0 is shown black.

Through the above displacement correction, whereby those points in the two images which correspond to the same points on the road surface are made to coincide in coordinates, usually, in the differential image, the pixels where the road surface appears are given a pixel value of 0. Also through this displacement correction, however, the shadow part of the vehicle itself comes to appear at different positions between the compared images, with the result that some pixels near an end part of the shadow part of the vehicle itself (those near the boundary between where the shadow appears and where there is no shadow) are classified into distinctive pixels. In FIG. 21D, the white region 910 occurs as a result of the pixels in that end part being classified into distinctive pixels.

Moreover, displacement detection based on image data and displacement correction based on its result are not free from errors, and, due to these errors, an end part of a planar sign drawn on a road surface (such as a white line indicating a parking area) may be included in a solid object region. An end part of a planar sign that has come to be included in a solid object region can be regarded as noise resulting from differentiating processing (differentiating noise).

Incidentally, there has also been proposed a method for identifying the position of the sun and the position of a shadow of a vehicle itself based on the position of smear in an image. This method, however, is not universal because no smear may occur depending on the fitting angle of a camera. In particular, with a rear camera that monitors rearward of a vehicle, since it is installed so as to point obliquely downward, basically no smear occurs.

A region in which a shadow of a solid object appears, a region in which a shadow of a vehicle itself appears, and a region in which a planar sign appears (differentiating noise) as mentioned above - none of these regions is one in which a solid object to be truly detected is located; thus these regions should be excluded when a solid object region is estimated.

### SUMMARY OF THE INVENTION

According to one aspect of the present invention, a driving assistance system that includes a camera portion fitted to a mobile object to shoot the surroundings of the mobile object and that estimates, based on a camera image on a camera coordinate plane obtained from the camera portion, a solid object region, where the image data of a solid object appears, in an image based on the camera image comprises: a bird's eye conversion portion that projects mutually different first and second camera images from the camera portion onto a bird's eye view coordinate plane parallel to the ground to convert the first and second camera images into first and second bird's eye view images; a candidate region setting portion that compares the first and second bird's eye view images to set a solid object candidate region on the bird's eye view coordinate plane; and a solid object region estimation portion that detects, within the solid object candidate region, an unnecessary region to be excluded from the solid object region to estimate the solid object region from the remaining region obtained by excluding the unnecessary region from the solid object candidate region. Here, the solid object region estimation portion detects the unnecessary region based on the positional relationship between a camera position, which is the position of the camera portion as projected on the bird's eye view coordinate plane, and the positions of candidate pixels, which are pixels belonging to the solid object candidate region.

Specifically, in one embodiment, for example, the solid object region estimation portion detects the unnecessary region based on the results of checking, for each candidate pixel, whether or not the candidate pixel belongs to the unnecessary region based on the difference between the direction linking the camera position to the position of the candidate pixel and the distribution direction of the solid object on the bird's eye view coordinate plane.

More specifically, for example, the candidate pixels belonging to the solid object candidate region include first to Nth candidate pixels (where N is an integer of 2 or more); when linking lines linking, on the bird's eye view coordinate plane, the camera position to the first to Nth candidate pixels, respectively, are called first to Nth linking lines, the directions of the first to Nth linking lines differ from one another; and the solid object region estimation portion detects the distribution direction based on the length of the solid object candidate region along each linking line.

Further specifically, the solid object region estimation portion determines the length with respect to each linking line, and includes, in the distribution direction to be detected, the direction of the linking line corresponding to the greatest length.

Specifically, in another embodiment, for example, the candidate pixels belonging to the solid object candidate region include first to Nth candidate pixels (where N is an integer of 2 or more); when the linking lines linking, on the bird's eye view coordinate plane, the camera position to the first to Nth candidate pixels, respectively, are called the first to Nth linking lines, the directions of the first to Nth linking lines differ from one another; and the solid object region estimation portion detects the unnecessary region based on a length of the solid object candidate region along each linking line.

More specifically, for example, the solid object region estimation portion determines the length with respect to each linking line, identifies the linking line with respect to which the length determined are smaller than a predetermined lower limit, length, and detects the unnecessary region by recognizing that the candidate pixels located on the identified linking line belong to the unnecessary region.

Specifically, in another embodiment, for example, an object with a height equal to or greater than a predetermined reference height is dealt with as the solid object, and the solid object region estimation portion detects the unnecessary region by checking, for each candidate pixel, whether or not the candidate pixel belongs to the unnecessary region by comparing the length of the solid object candidate region along the corresponding linking line and the smallest length of the solid object on the bird's eye view coordinate plane based on the positional relationship and the reference height.

More specifically, for example, the smallest length is set one for each candidate pixel; the smallest length for the ith candidate pixel (where i is a natural number equal to or less than N) is set based on the positional relationship between the position of the ith candidate pixel and the camera position, the reference height, and the installation height of the camera portion; and the solid object region estimation portion compares the length of the solid object candidate region along the ith linking line corresponding to the ith candidate pixel with the smallest length set for the ith candidate pixel, and, if the former is smaller than the latter, judges that the ith candidate pixel belongs to the unnecessary region.

Specifically, in another embodiment, for example, when the solid object candidate region is formed out of a plurality of candidate regions separate from one another, the solid object region estimation portion determines, as the length of the solid object candidate region, the length of each candidate region, and, for each candidate region, compares the determined length with the smallest length to judge whether or not candidate pixels belonging to the candidate region belong to the unnecessary region.

According to another aspect of the present invention, a driving assistance system as described above is installed in a vehicle.

The significance and benefits of the invention will be clear from the following description of its embodiments. It should however be understood that these embodiments are merely examples of how the invention is implemented, and that the meanings of the terms used to describe the invention and its features are not limited to the specific ones in which they are used in the description of the embodiments.

### BRIEF DESCRIPTION OF THE DRAWINGS

FIG. 1 is a configuration block diagram of a driving assistance system embodying the invention;

FIG. 2 is an exterior side view of a vehicle to which the driving assistance system of FIG. 1 is applied.

FIG. 3 is a diagram showing the relationship between the optical center of a camera and the camera coordinate plane on which a camera image is defined;

FIG. 4 is a diagram showing the relationship between a camera coordinate plane and a bird's eye view coordinate plane;

FIG. 5 is a diagram showing a positional relationship among the camera portion shown in FIG. 1, a light source such as the sun, and a solid object in real space;

FIG. 6 is a diagram showing a solid object region on the bird's eye view coordinate plane;

FIG. 7 is a diagram in which a projected figure resulting from the camera portion being projected onto the bird's eye view coordinate plane is shown, along with a shadow region and a solid object region, on the bird's eye view coordinate plane;

FIG. 8 is an operation flow chart of a driving assistance system according to Example 1 of the invention;

FIGS. 9A and 9B are diagrams respectively showing, in connection with Example 1 of the invention, Q straight lines created on the bird's eye view coordinate plane and the lengths determined with respect to a plurality of such straight lines;

FIG. 10 is a diagram illustrating, in connection with Example 1 of the invention, how a solid object distribution center line is determined;

FIG. 11 is a diagram showing, in connection with Example 1 of the invention, a result of estimation of a solid object region;

FIG. 12 is a diagram illustrating, in connection with Example 1 of the invention, how a solid object distribution center line is determined;

FIG. 13 is an operation flow chart of a driving assistance system according to Example 2 of the invention;

FIG. 14 is a diagram showing, in connection with Example 3 of the invention, a relationship in terms of height between the camera portion and a solid object;

FIG. 15 is an operation flow chart of a driving assistance system according to Example 3 of the invention;

FIG. 16 is a diagram showing, in connection with Example 3 of the invention, an end region of a shadow of a vehicle set as part of a solid object candidate region, illustrating a method for removing the end region from the solid object candidate region;

FIG. 17 is a diagram showing, in connection with Example 3 of the invention, how an end region of a shadow of a vehicle and a region where the image data of a solid object appears are included in a solid object candidate region;

FIG. 18 is an internal configuration diagram of the camera portion according to Example 4 of the invention;

FIG. 19 is a functional block diagram of a driving assistance system according to Example 5 of the invention;

FIG. 20 is a diagram showing a result of estimation of a solid object region by a conventional method; and

FIGS. 21A to 21D are diagrams illustrating, in connection with a conventional method, why an end part of a shadow of a vehicle itself (the very vehicle on which a camera and a driving assistance system are installed) is included in a solid object region.

### DETAILED DESCRIPTION OF PREFERRED EMBODIMENTS

Hereinafter, embodiments of the present invention will be described specifically with reference to the drawings. Among different drawings referred to in the course of description, the same parts are identified by the same reference signs, and in principle no overlapping description of the same parts will be repeated. Prior to the description of practical examples (Examples 1 to 5), first the features common to them, or referred to in their description, will be described.

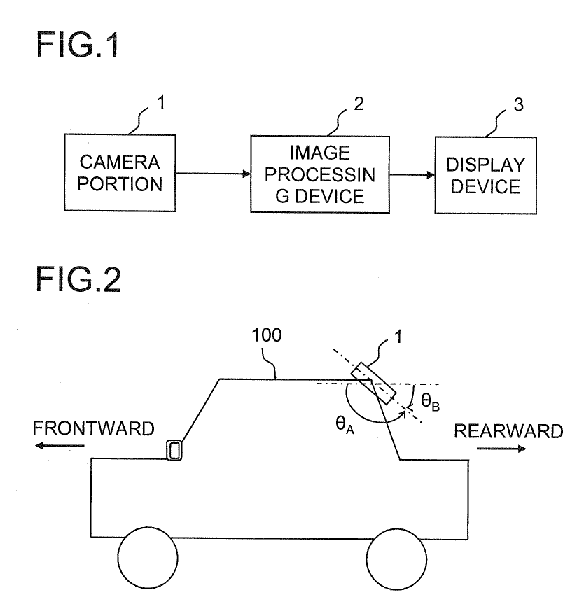

FIG. 1 is a configuration block diagram of a driving assistance system embodying the present invention. The driving assistance system of FIG. 1 is provided with a camera portion 1, an image processing device 2, and a display device 3. The camera portion 1 performs shooting, and outputs a signal representing an image obtained by the shooting to the image processing device 2. The image processing device 2 generates a display image from the image obtained from the camera portion 1. The image processing device 2 generates a video signal representing the display image, and outputs it to the display device 3. According to the video signal fed to it, the display device 3 displays the display image as video.

The camera portion 1 is built with one or more cameras. Example 4 described later will deal with operation performed when the camera portion 1 is built with two or more cameras; elsewhere, unless otherwise stated, it is assumed that the camera portion 1 is built with one camera (thus the camera portion 1 can be read simply as a camera 1).

An image obtained by the shooting by the camera portion 1 is called a camera image. A camera image represented by the output signal as it is of the camera portion 1 is often under the influence of lens distortion. Accordingly, the image processing device 2 performs lens distortion correction on a camera image represented by the output signal as it is of the camera portion 1, and then generates a display image based on a camera image that has undergone the lens distortion correction. In the following description, a camera image refers to one that has undergone lens distortion correction. Depending on the characteristics of the camera portion 1, however, lens distortion correction may be omitted.

FIG. 2 is an exterior side view of a vehicle 100 to which the driving assistance system of FIG. 1 is applied. As shown in FIG. 2, the camera portion 1 is arranged on a rear portion of the vehicle 100 so as to point rearward, obliquely downward. The vehicle 100 is, for example, an automobile. The optical axis of the camera portion 1 forms two angles with the horizontal plane, specifically angles represented by θ_{A} and θ_{B}, respectively, in FIG. 2. The angle θ_{B} is what is generally called an angle of depression, or a dip. The angle θ_{A} is taken as the inclination angle of the camera portion 1 relative to the horizontal plane. Here, 90°<θ_{A}<180° and simultaneously θ_{A}+θ_{B}=180°.

The camera portion 1 shoots the surroundings of the vehicle 100. The camera portion 1 is installed on the vehicle I 00 so as to have a field of view, in particular, rearward of the vehicle 100. The field of view of the camera portion 1 covers the road surface located rearward of the vehicle 100. In the following description, it is assumed that the ground lies on the horizontal plane, and that a “height” denotes one relative to the ground. Moreover, in the embodiment under discussion, the ground is synonymous with a road surface.

Used as the camera portion 1 is a camera employing a solid-state image-sensing device such as a CCD (charge-coupled device) or CMOS (complementary metal oxide semiconductor) image sensor. The image processing device 2 is built with, for example, an integrated circuit. The display device 3 is built with a liquid crystal display panel etc. A display device included in a car navigation system or the like may be shared as the display device 3 in the driving assistance system. The image processing device 2 may be integrated into, as part of, a car navigation system. The image processing device 2 and the display device 3 are installed, for example, near the driver's seat in the vehicle 100.

The image processing device 2, by coordinate conversion, converts a camera image into an image as seen from the point of view of a virtual camera, and thereby generates a bird's eye view image. The coordinate conversion for generating a bird's eye view image from a camera image is called “bird's eye conversion”.

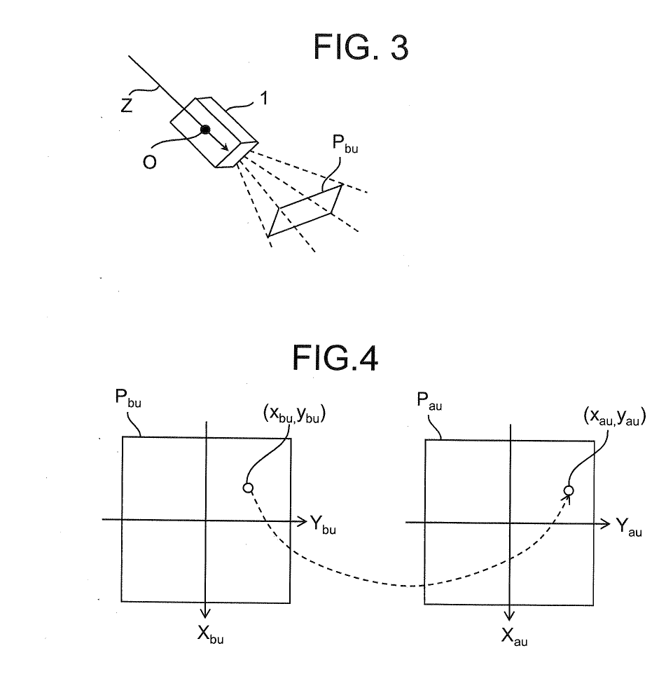

Refer to FIGS. 3 and 4. A plane perpendicular to the direction of the optical axis of the camera portion 1 is taken as a camera coordinate plane. In FIGS. 3 and 4, the camera coordinate plane is represented by a plane P_{bu}. The camera coordinate plane is a plane where a camera image is projected, and is parallel to the sensing surface of the solid-state image-sensing device of the camera portion 1. A camera image is formed by pixels arrayed two-dimensionally on the camera coordinate plane. The optical center of the camera portion 1 is represented by O, and the axis passing through the optical center O and parallel to the direction of the optical axis of the camera portion 1 is defined as the Z axis. The intersection between the Z axis and the camera coordinate plane is taken as the center of the camera image, and two axes lying on the camera coordinate plane and intersecting at that center are defined as the X_{bu} and Y_{bu} axes. The X_{bu} and Y_{bu} axes are parallel to the horizontal and vertical directions, respectively, of the camera image (it should be noted, however, that, in FIG. 4, the horizontal direction of the image appears as the up/down direction of the diagram). The position of a given pixel on the camera image is represented by its coordinates (X_{bu}, Y_{bu}) The symbols x_{bu} and y_{bu} represent the horizontal and vertical positions, respectively, of the pixel on the camera image. The vertical direction of the camera image corresponds to the direction of the distance from the vehicle 100; thus, on the camera coordinate plane, the greater the Y_{bu}-axis component (i.e. Y_{bu}) of a given pixel, the greater the distance from that pixel on the camera coordinate plane to the vehicle 100 and thus to the camera portion 1.

On the other hand, a plane parallel to the ground is taken as a bird's eye view coordinate plane. In FIG. 4, the bird's eye view coordinate plane is represented by a plane Pₐᵤ. A bird's eye view image is formed by pixels arrayed two-dimensionally on the bird's eye view coordinate plane. The perpendicular coordinate axes on the bird's eye view coordinate plane are defined as the Xₐᵤ and Yₐᵤ axes. The Xₐᵤ and Yₐᵤ axes are parallel to the horizontal and vertical directions, respectively, of the bird's eye view image. The position of a given pixel on the bird's eye view image is represented by its coordinates (xₐᵤ, yₐᵤ). The symbols xₐᵤ and yₐᵤ represent the horizontal and vertical positions, respectively, of the pixel on the bird's eye view image. The vertical direction of the bird's eye view image corresponds to the direction of the distance from the vehicle 100; thus, on the bird's eye view coordinate plane, the greater the Yₐᵤ-axis component (i.e. yₐᵤ) of a given pixel, the greater the distance from that pixel on the bird's eye view coordinate plane to the vehicle 100 and thus to the camera portion 1.

A bird's eye view image is a result of a camera image, which is defined on the camera coordinate plane, being projected onto the bird's eye view coordinate plane, and the bird's eye conversion for carrying out such projection can be achieved by one of known methods for coordinate conversion. For example, perspective projection conversion may be used, in which case a bird's eye view image can be generated by converting, according to formula (A-1) below, the coordinates (x_{bu}, y_{bu}) of each pixel on a camera image into coordinates (xₐᵤ, yₐᵤ) on the bird's eye view image. Here, the symbols f, h, and H represent, respectively, the focal length of the camera portion 1, the height at which the camera portion 1 is arranged (installation height), and the height at which the above-mentioned virtual camera is arranged. It is here assumed that the image processing device 2 previously knows the values of f, h, H, and θ_{A} (see FIG. 2).

$$( \begin{matrix}{x}_{a u} \\ {y}_{a u}\end{matrix} ) = ( \begin{matrix}\frac{{x}_{bu} ( fh sin {θ}_{A} + {Hy}_{a u} cos {θ}_{A}}{fH} \\ \frac{fh ( f cos {θ}_{A} - {y}_{bu} sin {θ}_{A} )}{H ( f sin {θ}_{A} + {y}_{bu} cos {θ}_{A} )}\end{matrix} ) \qquad ( A \text{-} 1 )$$

In practice, beforehand, according to formula (A-1), a table data is created that shows the correspondence between the coordinates (x_{bu}, y_{bu}) of each pixel on the camera image and the coordinates (xₐᵤ, yₐᵤ) of each pixel on the bird's eye view image, and the table data is stored in an unillustrated memory to form a lookup table (hereinafter referred to as the “bird's eye conversion LUT”). In actual operation, by use of the bird's eye conversion LUT, a camera image is converted into a bird's eye view image. Needless to say, a bird's eye view image may be generated by performing coordinate conversion calculation based on formula (A-1) each time a camera image is obtained.

The image processing device 2 is furnished with a function of estimating a solid object region within an image. A solid object region denotes a region in which a solid object (three-dimensional object) appears. A solid object is an object with height, such as a person. Any object without height, such as a road surface lying on the ground, is not a solid object. A solid object can be an obstacle to the traveling of the vehicle 100.

In bird's eye conversion, coordinate conversion is so performed that a bird's eye view image is continuous on the ground surface. Accordingly, when two bird's eye view images are obtained by the shooting of a single solid object from different angles of view, in principle, whereas the image of the road surface coincides between the two bird's eye view images, the image of the solid object does not (see, for example, JP-A-2006-268076). This characteristic is utilized to estimate a solid object region. Inconveniently, however, if a shadow of a solid object produced by external illumination, such as light from the sun, appears in an image, it is impossible, simply by utilizing the just mentioned characteristic, to distinguish between the part where the solid object itself appears and the part where its shadow appears, resulting in the position of the solid object being determined with degraded accuracy. With attention paid to this inconvenience, the image processing device 2 is furnished with a function of distinguishing between a part where a solid object itself appears (referred to as a body part in the following description) and a part where its shadow appears (referred to as a shadow part in the following description).

The operation and configuration of a driving assistance system incorporating this function will be described in detail below by way of practical examples, namely Examples 1 to 5. Unless inconsistent, any feature described in connection with one example applies equally to any other example.

### EXAMPLE 1

Example 1 will now be described. In Example 1, it is assumed that a solid object itself moves on the ground. First, a description will be given of the principle of how to distinguish between a body part and a shadow part of a such a mobile object.

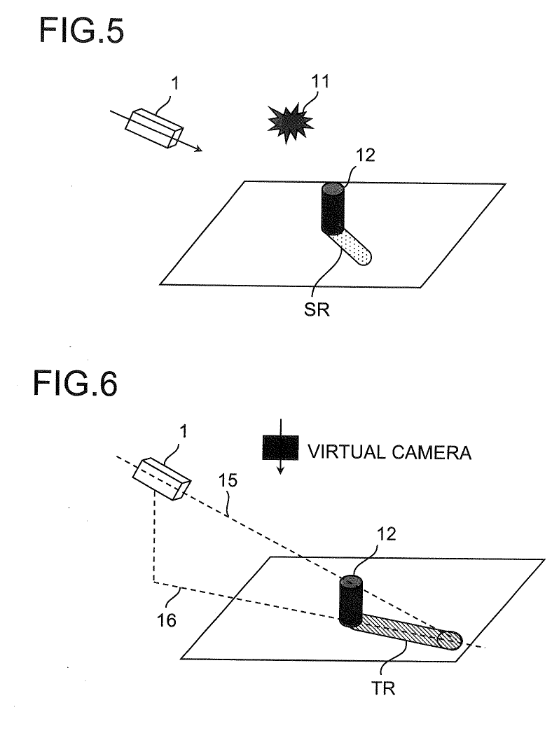

FIG. 5 shows a positional relationship among the camera portion 1, a light source (external illumination) 11, such as the sun, and a solid object 12 in real space. The solid object 12 is located within the shooting region of the camera portion 1. The dotted region indicated by the reference sign SR is the region of the shadow of the solid object 12 produced on the ground by the light source 11. When a camera image obtained by shooting under the condition of the positional relationship shown in FIG. 5 is converted into a bird's eye view image, as shown in FIG. 6, the solid object region on the bird's eye view image is distributed in the direction of a projected line 16, which is the line 15 linking the camera portion 1 to the solid object 12 as projected onto the ground. If, for the sake of argument, the camera portion 1 is thought of as one source of illumination, the solid object region on the bird's eye view image can be regarded as the region of the shadow of the solid object produced by that illumination. In FIG. 6, the hatched region indicated by the reference sign TR is that shadow region, which corresponds to the solid object region on the bird's eye view image. Needless to say, whereas the shadow region, corresponding to the solid object region TR, contains information on the color of the solid object, the shadow region SR produced by the light source 11 does not.

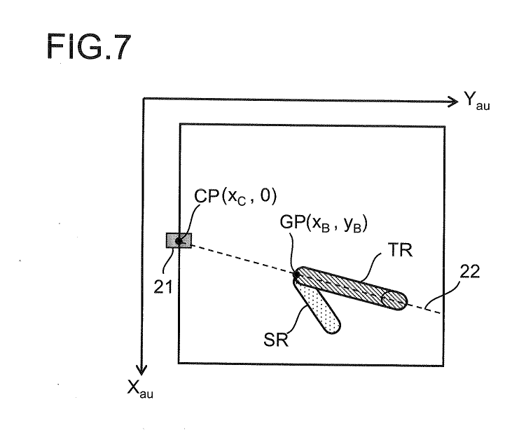

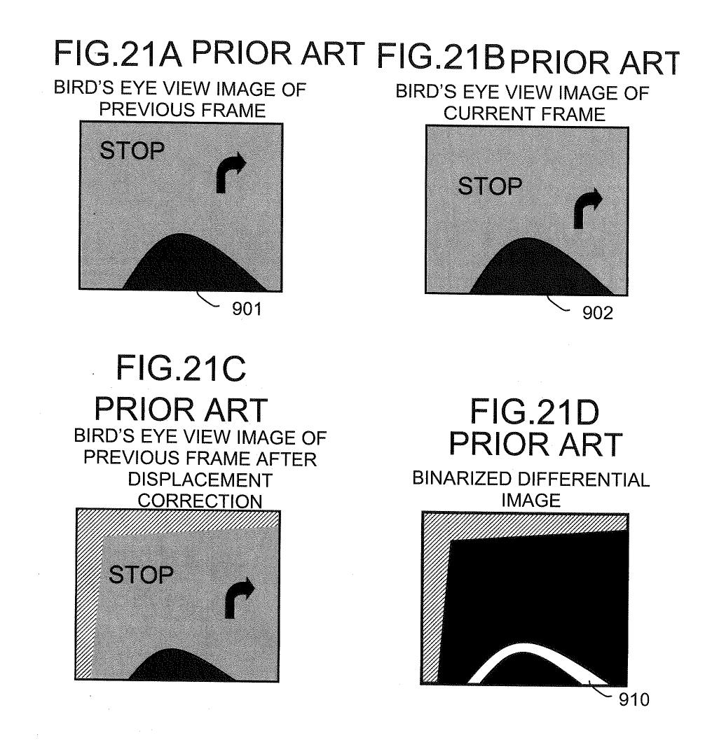

FIG. 7 is a diagram in which a projected FIG. 21 resulting from the camera portion 1 being projected onto the bird's eye view coordinate plane is shown, along with the shadow region SR and the solid object region TR, on the bird's eye view coordinate plane. The Yₐᵤ-axis component of the projected FIG. 21 is defined to be zero, and the position of the projected FIG. 21, i.e. the coordinates indicating the position at which the camera portion 1 is projected onto the bird's eye view coordinate plane, is represented by (x_{C}, 0). It is assumed that the coordinates (x_{C}, 0) are previously set in the image processing device 2. Moreover, that projection position is called the “camera position”, and the point CP having the coordinates (x_{C}, 0) is called the “camera position point”. More precisely, for example, the position at which the optical center O of the camera portion 1 is projected onto the bird's eye view coordinate plane is taken as the camera position. On the other hand, the point GP represents the point at which the solid object 12 makes contact with the ground on the bird's eye view coordinate plane, and the coordinates of the contact point GP is represented by (X_{B}, Y_{B}).

The coordinates (x_{C}, 0) and (x_{B}, y_{B}) are all those on the bird's eye view coordinate plane (or the bird's eye view image), and, in the following description, unless otherwise stated, it is assumed that all coordinates are those on the bird's eye view coordinate plane (or the bird's eye view image). Accordingly, for example, when a given point or pixel is mentioned as having coordinates (x_{A}, y_{A}), that means that the coordinates (xₐᵤ, yₐᵤ) of that point or pixel on the bird's eye view coordinate plane are (x_{A}, y_{A}).

In FIG. 7, the broken line indicated by the reference sign 22 is the line, corresponding to the projected line 16 in FIG. 6, linking the camera position point CP to the contact point GP (in other words, the straight line passing through the camera position point CP and the contact point GP). On the bird's eye view image, whereas the solid object region TR, starting at the contact point GP, is distributed in the direction of the linking line 22, the shadow region SR, likewise starting at the contact point GP, is not distributed in the direction of the linking line 22.

The image processing device 2 in FIG. 1 utilizes this characteristic of the solid object region TR—the direction in which it is distributed coinciding with the direction of the linking line 22—to separate the body part of a solid object from its shadow part. Specifically, first the two bird's eye view images are compared to extract a region including the solid object region TR and the shadow region SR; then the extracted region is divided into a region along the linking line 22 and the other region, and the latter region is eliminated from the extracted region; thus the solid object region TR alone is extracted accurately.

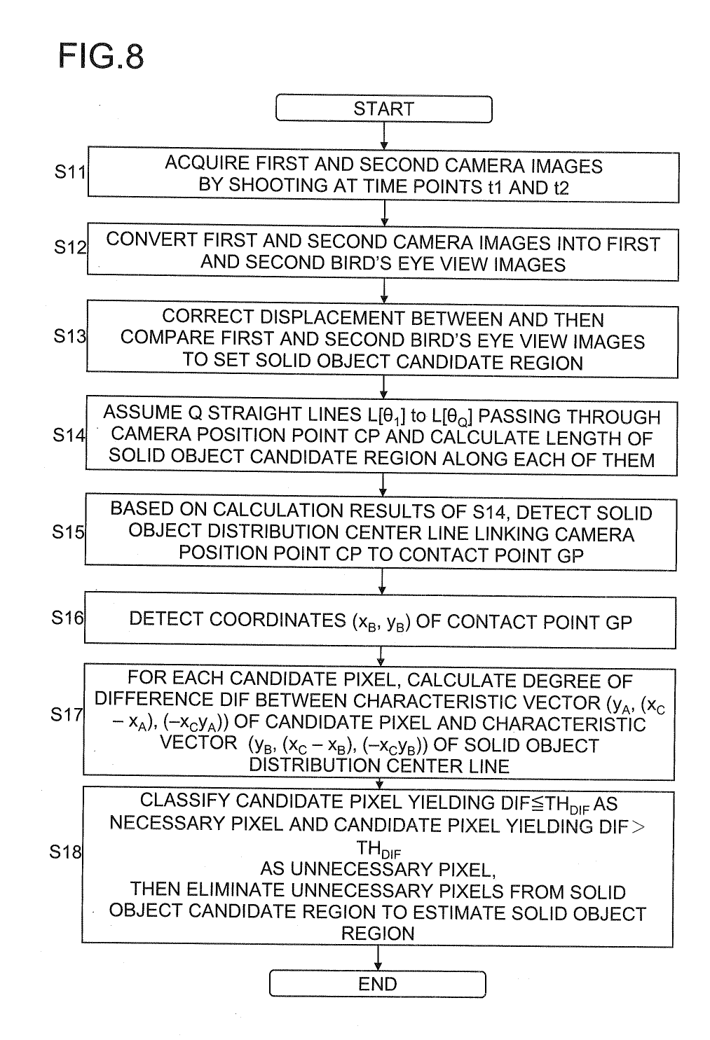

With reference to FIG. 8, a method for estimating a solid object region based on the principle described above will now be described. FIG. 8 is an operation flow chart of the driving assistance system, with special attention paid to estimation of a solid object region. The processing in steps S11 through S18 shown in FIG. 8 is executed by the image processing device 2. It is assumed that all the assumptions that have been made with reference to FIGS. 5 to 7 apply to the description of the operation under discussion.

Estimating a solid object region requires two camera images shot at different times. Accordingly, in step S11, the image processing device 2 acquires a plurality of camera images shot at different times. Here, it is assumed that the camera images thus acquired include one shot at time point t1 (hereinafter called the first camera image) and one shot at time point t2 (hereinafter called the second camera image). It is also assumed that time point t1 comes before time point t2. More precisely, for example, time point t1 is the midpoint of the exposure period of the first camera image, and time point t2 is the midpoint of the exposure period of the second camera image.

Moreover, it is assumed that, during the period between time points t1 and t2, the solid object 12 moves within the shooting region of the camera portion 1. It is further assumed that, during the period between time points t1 and t2, the vehicle 100 moves. Accordingly, the point of view of the camera portion 1 differs between at time point t1 and at time point t2. The vehicle 100 may instead remain at rest during the period between time points t1 and t2.

Subsequent to step S11, in step S12, the camera images acquired in step S11 are converted into bird's eye view images according to the bird's eye conversion LUT based on formula (A-1) above. The bird's eye view images based on the first and second camera images are called the first and second bird's eye view images, respectively.

In a case where the vehicle 100 moves during the period between time points t1 and t2, between the first and second bird's eye view images, a displacement occurs according to the movement. Subsequent to S12, in step S13, based on the image data of the first and second bird's eye view images, the displacement is detected, and the displacement between the first and second bird's eye view images is corrected. After this displacement correction, for a given single point on the road surface that appears on the first and second bird's eye view images, its position on the first bird's eye view image overlaps (coincides with) its position on the second bird's eye view image. Then, by comparing the bird's eye view images after displacement correction, a region including the solid object region TR and the shadow region SR is estimated, and the estimated region is taken as a solid object candidate region. The solid object candidate region is a composite region of the solid object region TR and the shadow region SR. The pixels belonging to the solid object candidate region are called the candidate pixels. Like the solid object region TR and the shadow region SR, the solid object candidate region is a region defined on the bird's eye view coordinate plane.

To estimate the solid object candidate region, i.e. a solid object region including a shadow region, it is possible to use any estimation method, known or not.

For example, it is possible to use the method disclosed in JP-A-2006-268076. In this case, by use of a known characteristic point extractor (such as the Harris corner detector, unillustrated), two characteristic points on the road surface are extracted from the first bird's eye view image; then image matching is performed between the first and second bird's eye view images to extract the two points on the second bird's eye view image corresponding to the two characteristic points. Thereafter, geometric conversion (such as affine transform) is applied to the first or second bird's eye view image such that the coordinates of the two characteristic points extracted from the first bird's eye view image and the coordinates of the two points extracted, as corresponding to those characteristic points, from the second bird's eye view image are equal. In this way, displacement correction is achieved. Then a differential image between the two bird's eye view images after the geometric conversion is generated, and this differential image is binarized to thereby estimate a solid object candidate region. Specifically, of all the pixels forming the differential image, those having pixel values equal to or greater than a predetermined threshold value are identified, and the region formed by the assembly of the thus identified pixels is estimated as a solid object candidate region. Here, pixel values are, for example, values of brightness.

While the foregoing deals with a method for estimating a solid object candidate region by use of two pairs of corresponding points, as disclosed in JP-A-2006-268076, three or more pairs of corresponding points may be used to estimate a solid object candidate region. It is also possible to use, instead, one of the methods disclosed in JP-A-2003-44996 etc. to estimate a solid object candidate region.

Alternatively, given that the displacement between the first and second bird's eye view images occurs according to the amount and direction of movement of the vehicle 100 between time points t1 and t2, the displacement between the first and second bird's eye view images may be detected based on the output signal, indicating the amount and direction of movement, of a sensor mounted on the vehicle 100. Examples of such sensors include a wheel speed sensor and a rudder angle sensor as disclosed in JP-A-2001-187553. Displacement correction based on a displacement detected by use of a sensor is achieved, in a similar manner as described above, by applying geometric conversion to the first or second bird's eye view image, and, in the first and second bird's eye view images after displacement correction, the points corresponding to a single given point on the road surface overlap (coincide in position). The operations after displacement correction are similar to those described above.

Subsequent to S13, in steps S14 and S15, the straight line, corresponding to the linking line 22 in FIG. 7, linking the camera position point CP to the contact point GP is detected as the solid object distribution center line. The solid object distribution center line is a straight line along the direction in which the solid object 12 is distributed on the bird's eye view coordinate plane, and therefore detecting the solid object distribution center line is equal to determining that distribution direction.

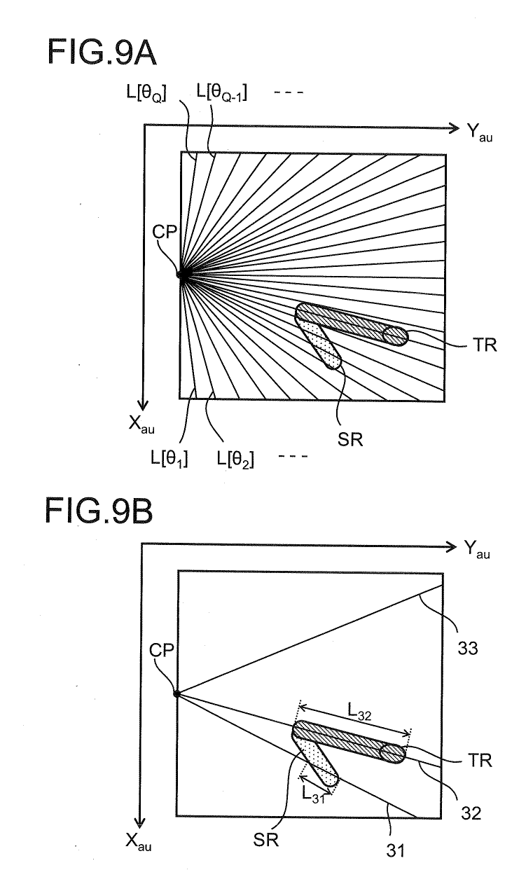

With references to FIGS. 9A and 9B, a method for detecting the solid object distribution center line will now be described. First, as shown in FIG. 9A, assume that Q straight lines L[θ₁], L[θ₂], . . , L[θ_{Q-1}], and L[θ_{Q}] (where Q represents an integer of 2 or more) passing through the camera position point CP are drawn on the bird's eye view coordinate plane. With the Xₐᵤ axis, the straight lines L[θ₁] to L[θ_{Q}] form mutually different angles θ₁ to θ_{Q}. Here, it is assumed that the angles θ₁ to θ_{Q} are the angles of the straight lines L[θ₁] to L[θ_{Q}] relative to the Xₐᵤ axis and fulfill 0°<θ₁<θ₂< . . . <θ_{Q-1}<θ_{Q}<180°. For example, the intervals between adjacent straight lines are set at 1°. In this case, θ₁=1°, θ₂=2°, . . . , θ_{Q-1}=178°, and θ_{Q}=179°, where Q=179.

Then, in step S14, for each of the straight lines L[θ₁] to L[θ_{Q}], the length of the solid object candidate region along it is determined. In FIG. 9B, three of the straight lines L[θ₁] to L[θ_{Q}] are shown as straight lines 31 to 33. The straight lines 31 and 32 intersect the solid object candidate region. The length L₃₁ of the solid object candidate region along the straight line 31 is the length over which the straight line 31 intersects the solid object candidate region, and the length L₃₁ is proportional to the number of pixels located on the straight line 31 within the solid object candidate region. The length L₃₂ of the solid object candidate region along the straight line 32 is the length over which the straight line 32 intersects the solid object candidate region, and the length L₃₂ is proportional to the number of pixels located on the straight line 32 within the solid object candidate region. In contrast, the straight line 33 does not intersect the solid object candidate region, and thus the length of the solid object candidate region along the straight line 33 equals zero.

After the length of the solid object candidate region along each of the straight lines L[θ₁] to L[θ_{Q}] is determined in this way, then, in step S15, based on the Q lengths thus determined, the solid object distribution center line is detected. Now, introduce a variable j representing the number of the straight lines L[θ₁] to L[θ_{Q}], and the length determined for the straight line L[θⱼ] is represented by LL[j] (where j is an integer of 1 or more but Q or less). In step S15, first the Q lengths LL[1] to LL[Q] determined in step S14 are each compared with a previously set reference length L_{REF} to identify, among the straight lines L[θ₁] to L[θ_{Q}], any having a length equal to or greater than the reference length L_{REF} (needless to say, the length here is the length of the solid object candidate region). Here, L_{REF}>0.

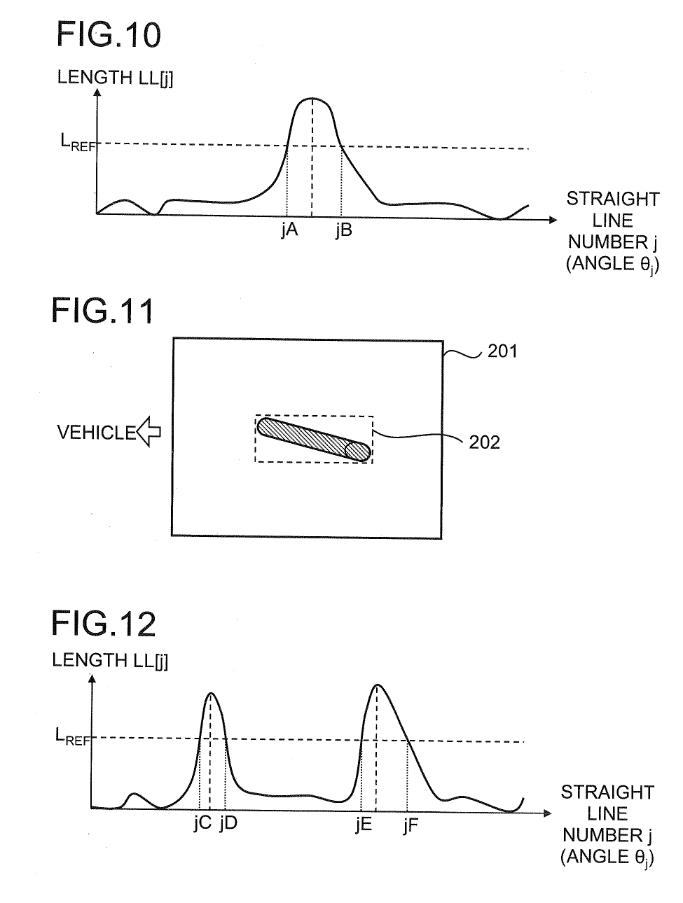

FIG. 10 shows an example of the relationship between the length LL[j] and the straight line number j as obtained in a case where there is only one solid object within the shooting region of the camera portion 1. FIG. 10 is thus also a diagram that shows an example of the relationship between the length LL[j] and the angle θⱼ. FIG. 10 shows that, of the straight lines L[θ₁] to L[θ_{Q}], only the straight lines L[θ_{jA}] to L[θ_{jB}] have lengths equal to or greater than the reference length L_{REF}. Here, 1<jA<jB<Q. In this case, the length LL[j], which is a function of the straight line number j (or the angle θⱼ), has a maximum length (here, a maximum value as one of extreme values) in the range of jA≦j≦jB. In step S15, the straight line having the maximum length is detected as the solid object distribution center line. Specifically, the straight lines L[θ_{jA}] to L[θ_{jB}] are dealt with as candidates for the solid object distribution center line and, of the straight lines L[θ_{jA}] to L[θ_{jB}], the one having the greatest length is selected as the solid object distribution center line. For example, when the maximum length is the length L₃₂ shown in FIG. 9B, the straight line 32 is detected as the solid object distribution center line.

In a case where there is only one solid object, the maximum length mentioned above (in other words, the local maximum length) equals the greatest length (greatest value) among the lengths LL[1] to LL[Q]. Thus, in a case where it is previously known that there is only one solid object, it is also possible to simply determine the greatest length among the lengths LL[1] to LL[Q] and detect the straight line corresponding to the greatest length as the solid object distribution center line.

In the example of processing described above, even such straight lines as do not pass through the solid object candidate region (such as the straight line 33) are assumed, and the length of the solid object candidate region is determined for those straight lines as well; it is, however, possible to omit the assumption of and determination for such straight lines. Accordingly, when the pixels belonging to the solid object candidate region are called the candidate pixels as described above, it can be said that, in steps S14 and 15, the following processing is performed: for each of a plurality of mutually different candidate pixels, the line linking the camera position point CP to the candidate pixel (in other words, the linking lines linking the camera position to the position of the candidate pixel) is set separately; then the length of the solid object candidate region along each such linking line is determined; and then the linking line corresponding to the maximum length is detected as the solid object distribution center line. Here, it is assumed that different linking lines run in different directions, i.e. form different angles with the Xₐᵤ axis.

After the solid object distribution center line is determined as described above, then the processing in step S16 is executed. In step S16, out of all the candidate pixels belonging to the solid object candidate region, the one located at the contact point GP is detected, and the coordinates of that candidate pixel are detected. Specifically, the coordinates (x_{B}, y_{B}) of the contact point GP are detected. More specifically, the coordinates of, of the candidate pixels located on the solid object distribution center line, the one closest to the camera position point CP is taken as (x_{B}, y_{B}).

An equation of the solid object distribution center line on the bird's eye view coordinate plane is given, in terms of the coordinates (x_{C}, 0) of the camera position point CP and the coordinates (x_{B}, y_{B}) of the contact point GP, as formula (B-1) below, and modifying formula (B-1) gives formula (B-2) below. Accordingly, the characteristic of the solid object distribution center line is given as a characteristic vector (y_{B}, (x_{C}−x_{B}), (−x_{C}y_{B})) composed of components y_{B}, (x_{C}−y_{B}), and (−x_{C}y_{B}).

$$\begin{matrix}\frac{{x}_{a u} - {x}_{C}}{{y}_{a u}} = \frac{{x}_{B} - {x}_{C}}{{y}_{B}} & ( B \text{-} 1 ) \\ {y}_{B} {x}_{a u} + ( {x}_{C} - {x}_{B} ) {y}_{a u} + ( - {x}_{C} {y}_{B} ) = 0 & ( B \text{-} 2 )\end{matrix}$$

On the other hand, when an arbitrary candidate pixel belonging to the solid object candidate region is taken as of interest and the coordinates of that candidate pixel of interest are taken as (x_{A}, y_{A}), then the characteristic of the line linking the candidate pixel of interest to the camera position point CP is given as a characteristic vector (y_{A}, (x_{C}−X_{A}), (−x_{C}y_{A})) composed of components y_{A}, (x_{C}−x_{A}), and (−x_{C}y_{A}). The characteristic vector (y_{A}, (x_{C}−x_{A}), (−x_{C}y_{A})) represents the positional relationship between the camera position and the position of the candidate pixel of interest. And the degree of difference DIF between the linking line corresponding to the characteristic vector (y_{A}, (x_{C}−x_{A}), (−x_{C}y_{A})) and the solid object distribution center line (i.e. the linking line 22 in FIG. 7) is given, as expressed by formula (B-3) below, as the absolute value of the inner product of the above two characteristic vectors.

DIF=|(y_{B},(x_{C}−x_{B}),(−x_{C}y_{B}))·(y_{A},(x_{C}−x_{A}),(−x_{C}y_{A}))|=|y_{B}y_{A}+(x_{C}−x_{B})(x_{C}−x_{A})+x_{C}²y_{B}y_{A}| (B-3)

The degree of difference DIF takes a value commensurate with the difference between the direction of the line linking the candidate pixel of interest to the camera position point CP and the direction of the solid object distribution center line. The image processing device 2, through calculating of the degree of difference DIF, judges that a candidate pixel on a linking line with a comparatively large difference in direction is a pixel belonging to the shadow region.

Specifically, subsequent to step S16, in step S17, according to formula (B-3), for each candidate pixel belonging to the solid object candidate region, the degree of difference DIF is calculated. Thereafter, in step S18, the degree of difference DIF for each candidate pixel is compared with a predetermined threshold value TH_{DIF}, so that each candidate pixel is classified either as a necessary pixel or as an unnecessary pixel. A necessary pixel is one where the image data of the body part of the solid object is supposed to appear; an unnecessary pixel is one where the image data of other than the body part of the solid object (for example, the image data of the shadow part of the solid object, or noise) is supposed to appear. Candidate pixels with which the degree of difference DIF is equal to or smaller than the threshold value TH_{DIF} are classified into necessary pixels, and candidate pixels with which the degree of difference DIF is greater than the threshold value TH_{DIF} are classified into unnecessary pixels. Then the image processing device 2 excludes the candidate pixels classified into unnecessary pixels from the solid object candidate region. In this way, the shadow region is completely or largely eliminated from the solid object candidate region.

The image processing device 2 identifies, from the region left after exclusion of unnecessary pixels, the position and size of the solid object region to be eventually detected. Specifically, it detects the very region composed of the group of necessary pixels, or a rectangular region including and surrounding that region, as a solid object region, and identifies the position and size of the thus detected solid object region. Here, a region formed by a group of a tiny number of pixels may be judged to originate from local noise and excluded from the solid object region.

The thus identified position and size of the solid object region are dealt with as the position and size of the solid object region on the first or second bird's eye view image. The region other than the solid object region is estimated as a ground region in which an object without height, such as the road surface, appears. Then, for example, as shown in FIG. 11, a display image is generated in which an indicator that makes the detected solid object region visually recognizable as distinct from the other region is superimposed on the first or second bird's eye view image, and it is displayed on the display device 3. In FIG. 11, the image 201 is the first or second bird's eye view image, and the broken-line rectangular frame 202 displayed superimposed on it corresponds to the just mentioned indicator.

It is also possible to estimate the position and size of the solid object region on the first or second camera image based on the position and size of the solid object region on the first or second bird's eye view image. Applying to the solid object region on the first or second bird's eye view image the inverse conversion of the geometric conversion (the bird's eye conversion described above) for obtaining a bird's eye view image from a camera image determines the position and size of the solid object region on the first or second camera image.

The sequence of processing in steps S11 through S18 is executed repeatedly. That is, the image processing device 2 acquires camera images at a predetermined cycle from the camera portion 1, generates from the camera images thus acquired one after another display images one after another, and keeps outputting the most recent display image to the display device 3. Thus, the display device 3 displays the most recent display image in a constantly updated fashion.

Through the processing described above, it is possible to detect a solid object region including no shadow region accurately. Although the above description of the processing performed in the driving assistance system pays special attention to separation of a shadow region, the processing described above simultaneously eliminates differential noise originating from a planar sign drawn on a road surface (such as a white line indicating a parking area).

Ideally, after displacement correction, the coordinates of a planar sign drawn on a road surface coincide between the first and second bird's eye view images, and thus, ideally, in the differential image generated from the two bird's eye view images, the pixel values at the pixels in the part corresponding to the planar sign are all zero. In reality, however, displacement detection and displacement correction are not free from errors, and thus pixel values equal to or greater than a predetermined value may appear in an edge part of a planar sign on the differential image, with the result that an end region of the planar sign may be included in a solid object candidate region. Such an end region of a planar sign corresponds to differential noise. Through the processing described above, such differential noise, having nothing to do with the direction of the solid object distribution center line, is eliminated as well.

The above description, given with reference to FIG. 10, of the operation in step S15 deals with a case where there is only one solid object within the shooting region of the camera portion 1. Even in a case where there are a plurality of solid objects apart from one another within the shooting region of the camera portion 1, by applying the processing in steps S15 through S18 to each of those solid objects, it is possible to estimate the solid object regions for them individually. As an example, an operation in a case where there are two solid objects will now be described. Refer to FIG. 12. FIG. 12 is a diagram showing an example of the relationship between the length LL[j] and the straight line number j as obtained in a case where there are two solid objects within the shooting region of the camera portion 1. It is assumed that the two solid objects are a first and a second solid object.

FIG. 12 shows that, of the straight lines L[θ₁] to L[θ_{Q}], only the straight lines L[θ_{jC}] to L[θ_{jD}] and L[θ_{jE}] to L[θ_{jF}] have lengths equal to or greater than the reference length L_{REF} (needless to say, the length here is the length of the solid object candidate region). Here, 1<jC<jD<jE<jF<Q. The lines L[θⱼ] in the range of jC≦j≦jD correspond to the first solid object, and the lines L[θⱼ] in the range of jE≦j≦jF correspond to the second solid object. In this case, the length LL[j], which is a function of the straight line number j (or the angle θⱼ), has a maximum length (hereinafter referred to as the first maximum length) in the range of jC≦j≦jD, and has another maximum length (hereinafter referred to as the second maximum length) in the range of jE≦j≦jF. Naturally, the first or second maximum length (here, a maximum value as one of extreme values) equals the greatest length (greatest value) among the lengths LL[1] to LL[Q].

in step S15, the straight lines having the maximum lengths are each detected as a solid object distribution center line. In the case under discussion, the straight line having the first maximum length is detected as a first solid object distribution center line, and the straight line having the second maximum length is detected as a second solid object distribution center line. Specifically, the straight lines L[θ_{jC}] to L[θ_{jD}] are dealt with as candidates for the first solid object distribution center line and, of the straight lines L[θ_{jC}] to L[θ_{jD}], the one having the greatest length is selected as the first solid object distribution center line. Likewise, the straight lines L[θ_{jE}] to L[θ_{jF}] are dealt with as candidates for the second solid object distribution center line and, of the straight lines L[θ_{jE}] to L[θ_{jF}], the one having the greatest length is selected as the second solid object distribution center line.

After the first and second solid object distribution center lines are detected, the processing in steps S16 through S18 is performed for each of the solid object distribution center lines. Specifically, the processing in steps S16 through S18 is performed with the first solid object distribution center line taken as of interest to identify the position and size of the solid object region corresponding to the first solid object distribution center line, and moreover the processing in steps S16 through S18 is also performed with the second solid object distribution center line taken as of interest to identify the position and size of the solid object region corresponding to the second solid object distribution center line. Then both of the solid object regions are dealt with as the solid object regions to be eventually estimated. In this way, with the method described above, it is possible to estimate solid object regions even for a plurality of solid objects.

### EXAMPLE 2

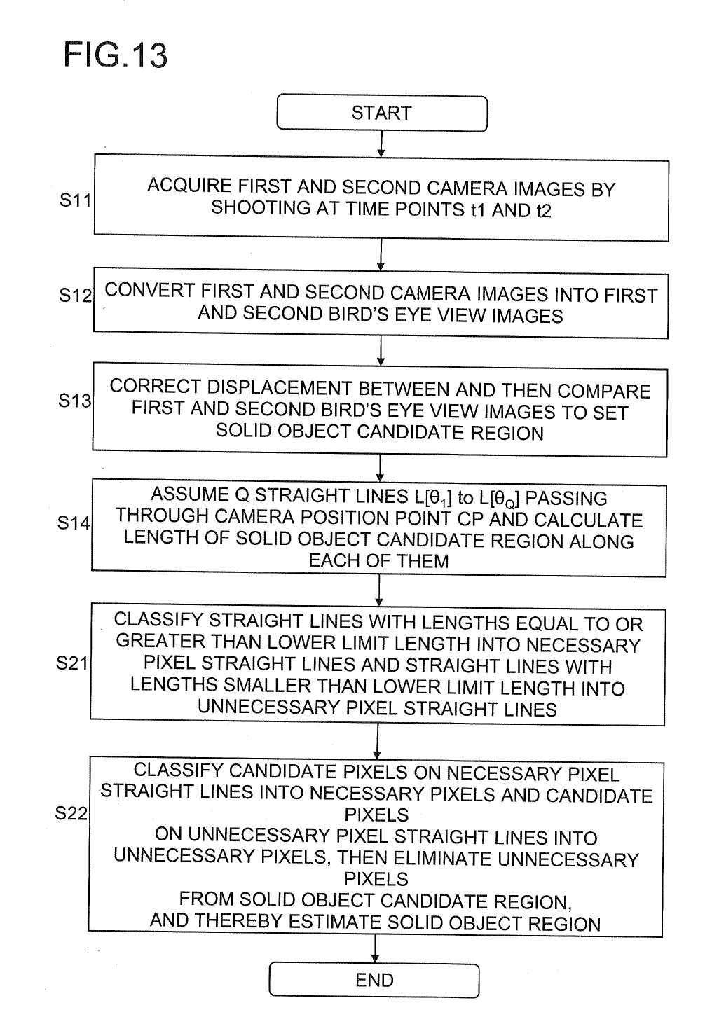

Example 2 will now be described. In Example 1, a solid object region is estimated through detection of a solid object distribution center line; by contrast, in Example 2, a solid object region is estimated without detection of a solid object distribution center line. The processing in Example 2 offers workings and benefits similar to those in Example 1. FIG. 13 is an operation flow chart of a driving assistance system according to Example 2. The processing in steps S11 through S14, S21, and S22 is executed by the image processing device 2. Example 2 is a partly modified version of Example 1, and therefore all the description of Example 1 applies also here unless otherwise stated.

First, through the processing in steps S11 through S13, a solid object candidate region is set, and then, through the processing in Step S14, the length of the solid object candidate region along each of straight lines L[θ₁] to L[θ_{Q}] is determined (see FIG. 9A). The processing thus far is the same as in Example 1.

Thereafter, in step S21, the image processing device 2 compares each of the lengths thus calculated with a previously set lower limit length. It classifies straight lines corresponding to lengths equal to or greater than the lower limit length into necessary pixel straight lines, and classifies straight lines corresponding to lengths smaller than the lower limit length into unnecessary pixel straight lines. For example, if the length of the solid object candidate region along the straight line L[θ₁] is equal to or greater than the lower limit length, the straight line L[θ₁] is classified as a necessary pixel straight line; if the length of the solid object candidate region along the straight line L[θ₁] is smaller than the lower limit length, the straight line L[θ₁] is classified as an unnecessary pixel straight line. The straight lines L[θ₂] to L[θ_{Q}] are handled likewise.

Subsequently, in step S22, the image processing device 2 classifies candidate pixels located on necessary pixel straight lines into necessary pixels, and classifies candidate pixels located on unnecessary pixel straight lines into unnecessary pixels; it then excludes the candidate pixels classified into unnecessary pixels from the solid object candidate region, and thereby estimates a solid object region. The operations after the candidate pixels are classified into necessary or unnecessary pixels are similar to those described in connection with Example 1. The sequence of processing in steps S11 through S14, S21, and S22 is executed repeatedly, so that, as described in connection with Example 1, the most recent display image is kept being outputted to the display device 3.

In the above example of processing, lengths are determined not only with respect to straight lines passing through the solid object candidate region but also with respect to straight lines not passing through the solid object candidate region. Here, the determination of lengths with respect to straight lines not passing through the solid object candidate region may be omitted. That is, determining the above length only with respect to straight lines passing through the solid object candidate region makes it possible to determine the solid object region to be estimated in step S22. Accordingly, the processing performed in steps S21 and S22 can be said to be as follows: for each of a plurality of mutually different candidate pixels, the line linking the camera position point CP to the candidate pixel is set separately; then the length of the solid object candidate region along each such linking line is determined; then linking lines corresponding to lengths smaller than the lower limit length are identified, and the candidate pixels located on those identified linking lines are, as unnecessary pixels, excluded from the solid object candidate region. Here, it is assumed that different linking lines run in different directions, i.e. form different angles with the Xₐᵤ axis.

### EXAMPLE 3

Example 3 will now be described. With a method according to Example 3, it is possible to cope with a shadow region of the vehicle 100 itself; it is also possible to cope with differential noise.

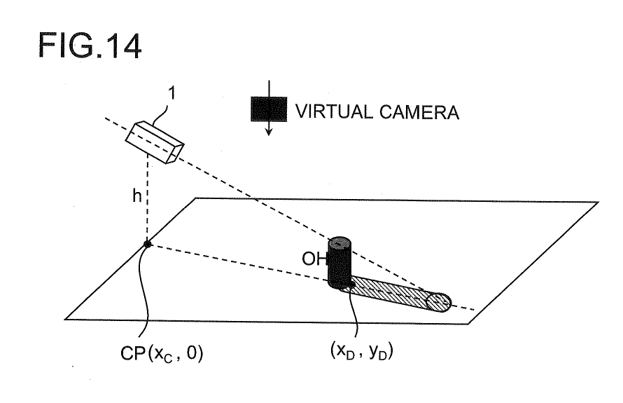

In Example 3, the smallest height of a solid object that a driving assistance system needs to detect is represented by OH. In the following description, the height represented by OH is called the reference height. In a driving assistance system according to Example 3, only an object whose height is equal to or greater than the reference height OH is dealt with as a solid object to be detected. For example, in a case where, according to a regulation such as “Safety Standards for Road Transport Vehicles”, a solid object to be detected (an obstacle to a vehicle) is defined as one whose size is equal to or larger than a cylinder with a diameter of 0.3 m and a height of 1 m, the reference height OH is set at 1 m, and this value of the reference height OH is previously given to the image processing device 2. FIG. 14 shows a relationship between the camera portion 1 and a solid object with a height equal to the reference height OH. As described earlier, h represents the height at which the camera portion 1 is arranged (installation height), and the coordinates of the camera position point CP are (x_{C}, 0)

The coordinates of an arbitrary pixel on the bird's eye view coordinate plane are represented by (x_{D}, y_{D}) If, for the sake of argument, a pixel with coordinates (x_{D}, y_{D}) is located at the point at which a solid object with a height equal to or greater than the reference height OH makes contact with the ground, then, on the bird's eye view coordinate plane, the length of the solid object along the line linking that pixel to the camera position point CP is equal to or greater than the length L_{MIN} given by formula (C-1) below.

$$\frac{OH}{h} = \frac{{L}_{MIN}}{{L}_{MIN} + \sqrt{{( {x}_{D} - {x}_{C} )}^{2} + {y}_{D}^{2}}} \qquad ( C \text{-} 1 )$$

The length represented by L_{MIN} is the smallest length of the image region that a solid object with a height equal to or greater than the reference height OH produces on the bird's eye view coordinate plane; accordingly the length represented by L_{MIN} is called the smallest length. Moreover, since L_{MIN} is a function of x_{D} and y_{D}, their association is expressed as L_{MIN}(x_{D}, y_{D}). Based on formula (C-1), the smallest length L_{MIN}(x_{D}, y_{D}) is given by formula (C-2) below.

$${L}_{MIN} ( {x}_{D} , {y}_{D} ) = \frac{OH \sqrt{{( {x}_{D} - {x}_{C} )}^{2} + {y}_{D}^{2}}}{h - OH} \qquad ( C \text{-} 2 )$$

Based on the values of h, OH, and x_{C}, the image processing device 2 calculates the smallest length L_{MIN}(x_{D}, y_{D}) for every pixel on the bird's eye view coordinate plane, and saves, in an internal memory (unillustrated) provided in itself, a smallest length table in which data representing the calculated results are stored. The size of the smallest length table thus equals the image size of the bird's eye view image. In Example 3, a solid object region is estimated by use of this smallest length table.

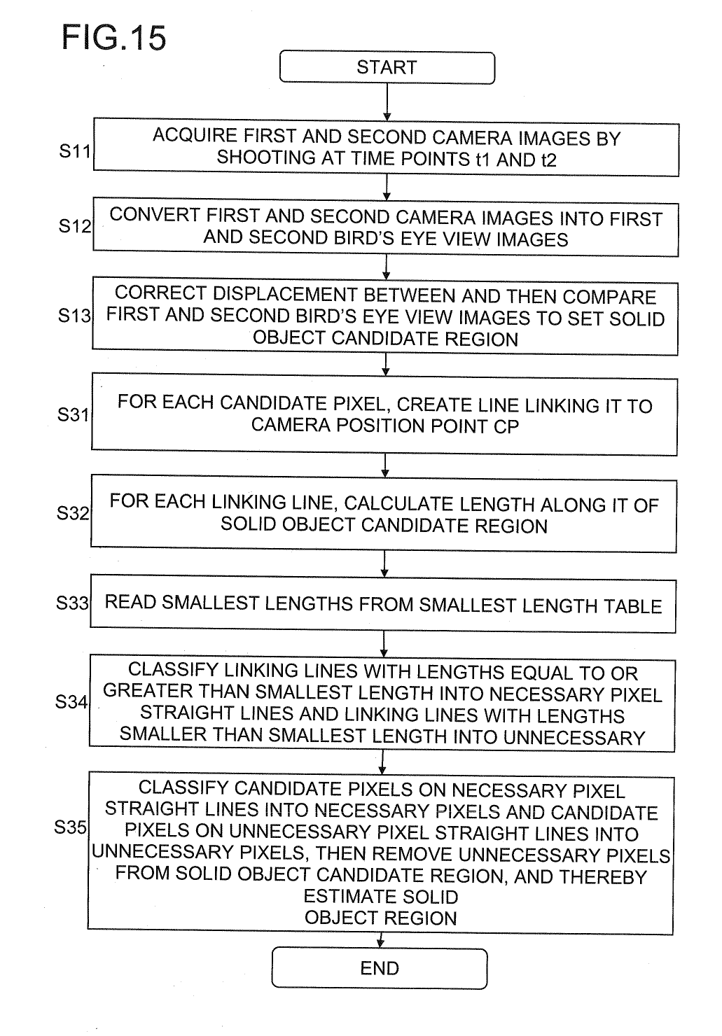

Now, with reference to FIG. 15, the operation of a driving assistance system according to Example 3 will be described. FIG. 13 is an operation flow chart of a driving assistance system according to Example 3. The processing in steps S11 through S13 and in steps S31 through S35 is executed by the image processing device 2. Unless otherwise stated, and unless inconsistent, all the description of Example 1 applies also here.

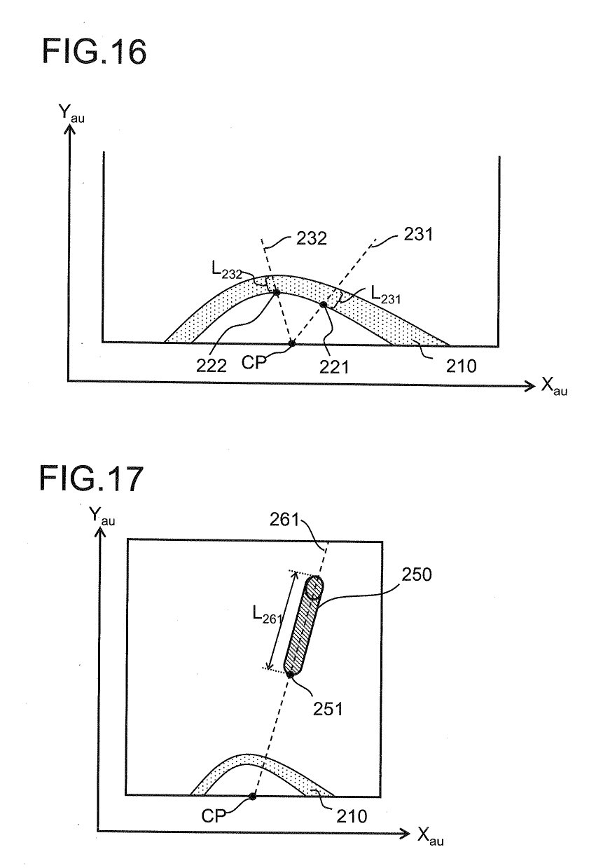

First, through the processing in steps S11 through S13, a solid object candidate region is set. The processing thus far is the same as in Example 1. Assume now that an end region of a shadow of the vehicle 100, i.e. a region at the boundary between parts where a shadow of the vehicle 100 appears and does not appear, is included in the solid object candidate region. FIG. 16 shows a positional relationship between that end region and the camera position point CP on the bird's eye view coordinate plane. In FIG. 16, the end region included in the solid object candidate region is shown as a dotted region 210. The region 210 corresponds to the region 910 in FIG. 21D. It should be noted that, in FIG. 16, and also in FIG. 17 described later, unlike in FIG. 7 etc., the up/down direction of the diagram corresponds to the Yₐᵤ-axis direction.

After the solid object candidate region is set in step S13, the processing in steps S31 through S35 is executed sequentially. In step S31, the image processing device 2 takes each candidate pixel belonging to the solid object candidate region as of interest, and creates the line linking the candidate pixel of interest to the camera position point CP. As examples, FIG. 16 shows candidate pixels 221 and 222 each taken as of interest separately. The coordinates of the candidate pixels 221 and 222 are represented by (x₁, y₁) and (x₂, y₂) respectively. The broken-line straight lines indicated by the reference signs 231 and 232 represent the lines linking the candidate pixels 221 and 222, respectively, to the camera position point CP.

Subsequently, in step S32, for each linking line created in step S31, the length of the region 210, as part of the solid object candidate region, along the linking line is calculated. For the linking line 231, a length L₂₃₁ is calculated, and for the linking line 232, a length L₂₃₂ is calculated. The length L₂₃₁ of the region 210 along the linking line 231 is the length over which the linking line 231 intersects the region 210, and thus the length L₂₃₁ is proportional to the number of pixels located on the linking line 231 within the region 210. The length L₂₃₂ of the region 210 along the linking line 232 is the length over which the linking line 232 intersects the region 210, and thus the length L₂₃₂ is proportional to the number of pixels located on the linking line 232 within the region 210.

On the other hand, in step S33, the image processing device 2 reads the smallest lengths stored in the smallest length table. The smallest lengths thus read include the smallest length for the linking line 231 (in other words, the smallest length for the candidate pixel 221) and the smallest length for the linking line 232 (in other words, the smallest length for the candidate pixel 222). The smallest length for the linking line 231 is the smallest length with x_{D}=x₁ and y_{D}=y₁, i.e. L_{MIN}(x₁, y₁); the smallest length for the linking line 232 is the smallest length with x_{D}=x₂ and y_{D}=y₂, i.e. L_{MIN}(x₂, y₂). The other candidate pixels are handled likewise.

Subsequently, in step S34, for each linking line, the length calculated in step S32 is compared with the smallest length read in step S33. A linking line corresponding to a length equal to or greater than the smallest length is classified as a necessary pixel straight line, and a linking line corresponding to a length smaller than the smallest length is classified as an unnecessary pixel straight line. For example, if L₂₃₁≧L_{MIN}(x₁, y₁), the linking line 231 is classified as a necessary pixel straight line; if L₂₃₁<L_{MIN}(x₁, y₁), the linking line 231 is classified as an unnecessary pixel straight line. Likewise, if L₂₃₂>L_{MIN}(x₂, y₂), the linking line 232 is classified as a necessary pixel straight line; if L₂₃₂<L_{MIN}(x₂, y₂), the linking line 232 is classified as an unnecessary pixel straight line. The other linking lines are handled likewise.

Thereafter, in step S35, the image processing device 2 classifies the candidate pixels located within the region 210 and in addition on necessary pixel straight lines into necessary pixels, and classifies the candidate pixels located within the region 210 and in addition on unnecessary pixel straight lines into unnecessary pixels; it then excludes the candidate pixels classified into unnecessary pixels from the solid object candidate region, and thereby estimates a solid object region. The necessary pixels are those where it is estimated that there appears the image data of a body part of a solid object with a height equal to or greater than the reference height OH. The unnecessary pixels are those where it is estimated that there appear the image data of a body part of a solid object with a height smaller than the reference height OH, the image data of a shadow part of the vehicle 100, differential noise, etc. The operations after the candidate pixels are classified into necessary or unnecessary pixels are similar to those described in connection with Example 1. The sequence of processing in steps S11 through S13 and steps S31 through S35 is executed repeatedly, so that, as described in connection with Example 1, the most recent display image is kept being outputted to the display device 3.

For the sake of convenience of description, the operation of the driving assistance system has been described with attention paid to and around a shadow part of the vehicle 100; in a case where a solid object to be detected is present within the field of view of the camera portion 1, the solid object candidate region set in step S13 includes, in addition to the region 210, a region 250 where the image data of the solid object appears. In this case, the solid object candidate region is as shown in FIG. 17. The region 210 and the region 250 lie separately from, without any overlap between, each other on the bird's eye view coordinate plane. It should be noted that, although the same region 210 appears in both FIGS. 16 and 17, for the sake of convenience of illustration, it is shown with different sizes between the two diagrams.

In a case where the solid object candidate region includes regions 210 and 250 separate from each other, the image processing device 2 performs on the region 250 processing similar to that it performs on the region 210. Specifically, each candidate pixel belonging to the region 250 as part of the solid object candidate region is taken as of interest, and a line linking the candidate pixel of interest to the camera position point CP is created. Then, for each linking line thus created, the length of the region 250 along the linking line is calculated and on the other hand the smallest length stored in the smallest length table is read so that the former is compared with the latter. Then linking lines corresponding to lengths equal to or greater than the smallest lengths are classified into necessary pixel straight lines, and linking lines corresponding to lengths smaller than the smallest lengths are classified into unnecessary pixel straight lines.

For example, when a candidate pixel 251 with coordinates (x₃, y₃) within the region 250 is taken of interest, the linking line 261 connecting the candidate pixel 251 to the camera position point CP is created. Then the length L₂₆₁ of the region 250 along the linking line 261 is calculated, and on the other hand the L_{MIN}(x₃, y₃) is read. If L₂₆₁≧L_{MIN}(x₃, y₃), the linking line 261 is classified as a necessary pixel straight line, and if L₂₆₁<L_{MIN}(x₃, y₃), the linking line 261 is classified as an unnecessary pixel straight line.

After all linking lines are classified into necessary or unnecessary pixel straight lines, candidate pixels located within the region 250 and in addition on necessary pixel linking lines are classified into necessary pixels, and candidate pixels located within the region 250 and in addition on unnecessary pixel linking lines are classified into unnecessary pixels. Then the candidate pixels classified into unnecessary pixels are excluded from the solid object candidate region, and thereby a solid object region is estimated.

Although a method according to Example 3 has been described with particular attention paid to a shadow region of the vehicle 100, it can also cope with a shadow region of a stationary solid object such as a wall, and with differential noise. That is, with a method according to Example 3, it is possible to estimate an accurate solid object region excluding not only a shadow region of a vehicle 100 but even a shadow region of a stationary solid object and differential noise.

In the above example of processing, a smallest length table whose size equals the image size of the bird's eye view image is previously created and, by use of this smallest length table, a solid object region is estimated. In the estimation here, the smallest lengths of pixels other than the candidate pixels are not referred to. Thus, instead of a smallest length table being previously created, every time a solid object candidate region is set, the smallest lengths corresponding to candidate pixels may be calculated whenever necessary according to formula (C-2).

### EXAMPLE 4

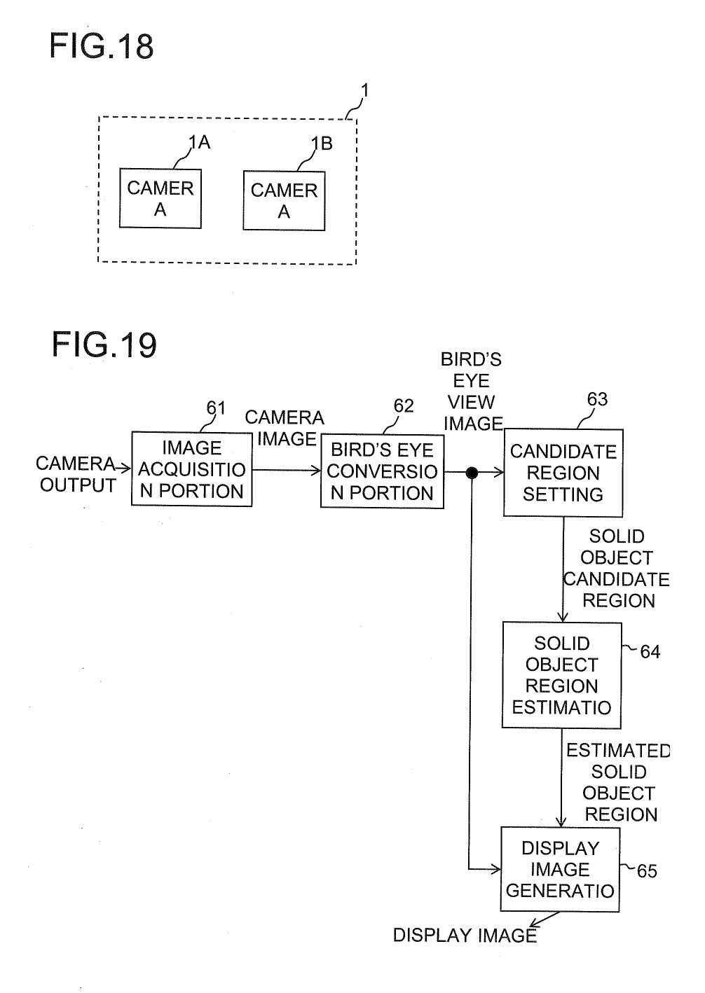

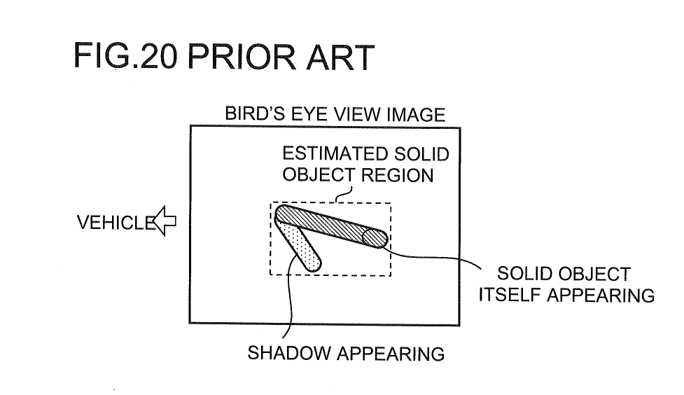

Although the operation of a driving assistance system has been described on the assumption that the camera portion 1 is built with one camera, even in cases where the camera portion 1 is built with a plurality of cameras, the methods described in connection with Examples 1 to 3 can be applied. As an example, the operation of a driving assistance system in a case where the camera portion 1 is built with two cameras will now be described as Example 4. It is assumed that the two cameras consist of, as shown in FIG. 18, cameras 1A and 1B. The cameras 1A and 1B together form, for example, a stereo camera.

The cameras 1A and 1B are both installed in a rear part of a vehicle 100 so as to have a field of view rearward of the vehicle 100, the field of view of the cameras 1A and 1B covering the road surface located rearward of the vehicle 100. The cameras 1A and 1B both have an inclination angle of θ_{A} (see FIG. 2). There is, however, a slight difference in point of view between the cameras 1A and 1B, and this difference produces a slight difference between two images that are shot by the cameras 1A and 1B, respectively, at the same time. Except being different in point of view, the cameras 1A and 1B are the same.

In a case where a camera portion 1 built with cameras 1A and 1B is used, the cameras 1A and 1B are made to shoot simultaneously, and the resulting camera images obtained from the cameras 1A and 1B are dealt with as a first and a second camera image respectively. The image processing device 2 performs bird's eye conversion on the first and second camera images from the cameras 1A and 1B. The bird's eye view image obtained through bird's eye conversion of the first camera image from the camera 1A and the bird's eye view image obtained through bird's eye conversion of the second camera image from the camera 1B are dealt with as a first and a second bird's eye view image respectively.

Here, although the first and second bird's eye view images result from shooting performed simultaneously, due to the difference in point of view between the cameras 1A and 1B, in principle, between the two bird's eye view images, whereas the image of the road surface coincides, the image of a solid object does not. This characteristic is utilized to detect, first, a solid object candidate region.

Specifically, the displacement between the first and second bird's eye view images is corrected. Points corresponding to a single given point on the road surface appear on the first and second bird's eye view images respectively and, after the displacement correction, those points on the first and second bird's eye view images overlap (coincide in coordinate). Displacement correction is achieved by applying geometric conversion to the first or second bird's eye view images, and it is assumed that what geometric conversion to apply is previously determined based on how the cameras 1A and 1B are arranged. Displacement correction may instead be performed at the stage of camera images.

The operations after displacement correction are similar to those described in connection with any of Examples 1 to 3. Specifically, based on the differential image between the two bird's eye view images after displacement correction, a solid object candidate region on the bird's eye view coordinate plane is set; then, by removing unnecessary pixels from the solid object candidate region, a solid object region is estimated. Here, the position at which the camera 1A (more precisely, for example, the optical center of the camera 1A) is projected onto the bird's eye view coordinate plane, or the position at which the camera 1B (more precisely, for example, the optical center of the camera 1B) is projected onto the bird's eye view coordinate plane, or the midpoint between those two projection positions is taken as the camera position, of which the coordinates are represented by (x_{C}, 0).

### EXAMPLE 5

Example 5 will now be described. In Example 5, a description will be given of an example of a functional block diagram of a driving assistance system corresponding to the practical examples described above. FIG. 19 is a functional block diagram of a driving assistance system according to Example 5. The driving assistance system according to Example 5 includes blocks referred to by the reference signs 61 to 65, and these blocks referred to by the reference signs 61 to 65 are provided in the image processing device 2 in FIG. 1.

An image acquisition portion 61 acquires one camera image after another based on the output signal of the camera portion 1. The image data of each camera image is fed from the image acquisition portion 61 to a bird's eye conversion portion 62. The bird's eye conversion portion 62 applies bird's eye conversion to a first and a second camera image fed from the image acquisition portion 61, and thereby generates a first and a second bird's eye view image.

The image data of the first and second bird's eye view images is fed to a candidate region setting portion 63 and to a display image generation portion 65. The candidate region setting portion 63 performs, for example, the processing in step S13 (see FIG. 8 etc.) on the first and second bird's eye view images, and thereby sets a solid object candidate region. A solid object region estimation portion 64 receives from the candidate region setting portion 63 information indicating the position and size of the solid object candidate region thus set, and, by one of the methods described in connection with Examples 1 to 4, removes an unnecessary region consisting of a group of unnecessary pixels from the solid object candidate region, thereby to estimate a solid object region. The display image generation portion 65 receives from the solid object region estimation portion 64 information indicating the position and size of the solid object region thus estimated, and based on that information, processes the first or second bird's eye view image so as to make the solid object region visually recognizable, thereby to generate a display image. Instead, an image obtained by processing the first or second camera image so as to make the solid object region visually recognizable may be generated as a display image.

### Modifications and Variations

The specific values given in the description above are merely examples, which, needless to say, may be modified to any other values. In connection with the embodiments described above, modified examples or supplementary explanations applicable to them will be given below in Notes 1 to 5. Unless inconsistent, any part of the contents of these notes may be combined with any other.

Note 1: Although a method for obtaining a bird's eye view image from a camera image by perspective projection conversion is described, it is also possible to obtain a bird's eye view image from a camera image, instead, by planar projection conversion. In that case, a homography matrix (planar projection matrix) for converting the coordinates of the individual pixels on a camera image into the coordinates of the individual pixels on a bird's eye view image is determined by camera calibration conducted prior to actual use. The homography matrix is determined by a known method. Then, based on the homography matrix, a camera image is converted into a bird's eye view image.

Note 2: Although the above examples deal with cases where the camera portion 1 is installed in a rear part of the vehicle 100 so as to have a field of view rearward of the vehicle 100, it is also possible to install the camera portion 1, instead, in a front or side part of the vehicle 100 so as to have a field of view frontward or sideward of the vehicle 100. Even with the camera portion 1 so installed, it is possible to perform processing similar to that described above, including processing for estimating a solid object region.

Note 3: In the embodiments described above, a display image based on a camera image obtained from a single camera portion is displayed on the display device 3. Instead, it is also possible to install a plurality of camera portions each similar to the camera portion 1, on the vehicle 100 and generate a display image based on a plurality of camera images obtained from the plurality of camera portions. For example, a total of four camera portions for shooting frontward, rearward, left-sideward, and right-sideward, respectively, of the vehicle 100 are installed on the vehicle 100, and processing similar to that described above is performed on the camera images obtained from those camera portions so that a solid object region is estimated for each camera portion; on the other hand, four images (for example, four bird's eye view images) based on the camera images from the four camera portions are merged together. The merged image resulting from this merging is, for example, an all-around bird's eye view image as disclosed in JP-A-2006-287892, and thus a solid object region having a shadow or noise eliminated from it is estimated all over the all-around bird's eye view image. Then, the result of the estimation of the solid object region is reflected in the merged image to generate a display image for display on the display device 3.

Note 4: In the embodiments described above, an automobile is dealt with as an example of a vehicle. It is, however, also possible to apply the present invention to vehicles that are not classified into automobiles, and even to mobile objects that are not classified into vehicles. For example, a mobile object that is not classified into vehicles has no wheel and moves by use of a mechanism other than a wheel. For example, it is possible to apply the present invention to, as a mobile object, a robot (unillustrated) that moves around inside a factory by remote control.

Note 5: The functions of the image processing device 2 shown in FIG. 1 and of the blocks shown in FIG. 19 are realized in hardware, in software, or in a combination of hardware and software. All or part of the functions of the image processing device 2 shown in FIG. 1 and of the blocks shown in FIG. 19 may be prepared in the form of a software program so that, when this software program is executed on a computer, all or part of those functions are realized.

What is claimed is:

1. A driving assistance system that includes a camera portion fitted to a mobile object to shoot surroundings of the mobile object and that estimates, based on a camera image on a camera coordinate plane obtained from the camera portion, a solid object region, where image data of a solid object appears, in an image based on the camera image,
the driving assistance system comprising:
a bird's eye conversion portion that projects mutually different first and second camera images from the camera portion onto a bird's eye view coordinate plane parallel to the ground to convert the first and second camera images into first and second bird's eye view images;
a candidate region setting portion that compares the first and second bird's eye view images to set a solid object candidate region on the bird's eye view coordinate plane; and
a solid object region estimation portion that detects, within the solid object candidate region, an unnecessary region to be excluded from the solid object region to estimate the solid object region from a remaining region obtained by excluding the unnecessary region from the solid object candidate region,
wherein the solid object region estimation portion detects the unnecessary region based on a positional relationship between a camera position, which is a position of the camera portion as projected on the bird's eye view coordinate plane, and positions of candidate pixels, which are pixels belonging to the solid object candidate region.

2. The driving assistance system according to claim 1,
wherein the solid object region estimation portion detects the unnecessary region based on results of checking, for each candidate pixel, whether or not the candidate pixel belongs to the unnecessary region based on a difference between a direction linking the camera position to the position of the candidate pixel and a distribution direction of the solid object on the bird's eye view coordinate plane.

3. The driving assistance system according to claim 2, wherein
the candidate pixels belonging to the solid object candidate region include first to Nth candidate pixels (where N is an integer of 2 or more),
when linking lines linking, on the bird's eye view coordinate plane, the camera position to the first to Nth candidate pixels, respectively, are called first to Nth linking lines, directions of the first to Nth linking lines differ from one another, and
the solid object region estimation portion detects the distribution direction based on a length of the solid object candidate region along each linking line.

4. The driving assistance system according to claim 3,
wherein the solid object region estimation portion determines the length with respect to each linking line, and includes, in the distribution direction to be detected, a direction of a linking line corresponding to a greatest length.

5. The driving assistance system according to claim 1, wherein
the candidate pixels belonging to the solid object candidate region include first to Nth candidate pixels (where N is an integer of 2 or more),
when linking lines linking, on the bird's eye view coordinate plane, the camera position to the first to Nth candidate pixels, respectively, are called first to Nth linking lines, directions of the first to Nth linking lines differ from one another, and
the solid object region estimation portion detects the unnecessary region based on a length of the solid object candidate region along each linking line.

6. The driving assistance system according to claim 5,
wherein the solid object region estimation portion determines the length with respect to each linking line, identifies a linking line with respect to which the length determined is smaller than a predetermined lower limit length, and detects the unnecessary region by recognizing that candidate pixels located on the identified linking line belong to the unnecessary region.

7. The driving assistance system according to claim 5, wherein
an object with a height equal to or greater than a predetermined reference height is dealt with as the solid object, and
the solid object region estimation portion detects the unnecessary region by checking, for each candidate pixel, whether or not the candidate pixel belongs to the unnecessary region by comparing a length of the solid object candidate region along the corresponding linking line and a smallest length of the solid object on the bird's eye view coordinate plane based on the positional relationship and the reference height.

8. The driving assistance system according to claim 7, wherein
the smallest length is set one for each candidate pixel,
the smallest length for an ith candidate pixel (where i is a natural number equal to or less than N) is set based on a positional relationship between the position of the ith candidate pixel and the camera position, the reference height, and an installation height of the camera portion, and
the solid object region estimation portion compares a length of the solid object candidate region along an ith linking line corresponding to the ith candidate pixel with the smallest length set for the ith candidate pixel, and, if the former is smaller than the latter, judges that the ith candidate pixel belongs to the unnecessary region.

9. The driving assistance system according to claim 7, wherein
when the solid object candidate region is formed out of a plurality of candidate regions separate from one another,
the solid object region estimation portion determines, as the length of the solid object candidate region, a length of each candidate region, and, for each candidate region, compares the determined length with the smallest length to judge whether or not candidate pixels belonging to the candidate region belong to the unnecessary region.

10. A vehicle as a mobile object comprising the driving assistance system according to claim 1.
